(19) United States
(12) Patent Application Publication
(10) Pub. No.: US 2024/0425279 A1
(43) Pub. Date: Dec. 26, 2024

(54) LOAD HANDLING DEVICE, STORAGE AND RETRIEVAL SYSTEM & METHOD

(71) Applicant: OCADO INNOVATION LIMITED, Hatfield, Hertfordshire (GB)

(72) Inventors: Philip CORSER, Hatfield, Hertfordshire (GB); Nathan COUNSELL, Hatfield, Hertfordshire (GB)

(73) Assignee: OCADO INNOVATION LIMITED, Hatfield, Hertfordshire (GB)

(21) Appl. No.: 18/682,962

(22) PCT Filed: Aug. 12, 2022
(86) PCT No.: PCT/EP2022/072738

§ 371 Date: Feb. 12, 2024

(30) Foreign Application Priority Data
Aug. 13, 2021 (GB) 2111638.9

(51) Int. Cl. B65G 1/137; B65G 1/04

(52) U.S. Cl. CPC B65G 1/1375; B65G 1/0478; B65G 2201/0235

(57) ABSTRACT

A load handling device for lifting and moving containers arranged in stacks in a storage structure. The storage structure includes a track structure arranged in a grid pattern which defines a plurality of grid cells above the stacks of containers. The load handling device includes: a driving assembly configured to horizontally move the load handling device on the track structure; a lifting mechanism configured to lift a container from a stack; a power source; and an externally accessible power source compartment configured to electrically couple to the power source. The power source compartment is configured to removably receive the power source in a vertical direction.

### TECHNICAL FIELD

The present invention relates to a load handling device with an exchangeable power source and a method of exchanging a power source of a load handling device operating in a storage system.

### BACKGROUND

Some commercial and industrial activities require systems that enable the storage and retrieval of a large number of different products. WO2015/185628A2 describes a storage and retrieval system in which stacks of storage containers are arranged within a grid storage structure. The containers are accessed from above by load handling devices operative on rails or tracks located on the top of the grid storage structure.

Each load handling device is operated by a rechargeable battery. The rechargeable battery is typically charged in situ by driving a load handling device to a charging station located at the edge of the track structure. The load handling device remains stationary at the charging station while the battery is recharged. The charging period is a significant source of downtime for the load handling device and can be on the order of hours.

To alleviate the problem of charging downtime, the load handling device may be powered by an exchangeable battery. When the battery in the load handling device is depleted, the depleted battery is exchanged for a fully charged battery and therefore the charging downtime is reduced to the time it takes to exchange the battery, rather than being the time to charge the battery.

WO2015104263 discloses a remotely operated vehicle for picking up storage containers from an underlying storage system. The remotely operated vehicle comprises a main power source releasably coupled to the vehicle body. When the main power source is nearly depleted, the vehicle approaches a stationary charging station configured to decouple and transfer the depleted main power source from the vehicle to the charging station. After transferring the depleted main power source to the charging station, the vehicle moves to another charging station to couple to a charged main power source.

The system of WO2015104263 has a number of disadvantages. First, the vehicle is required to move between two charging stations to fully complete a power source exchange, which costs time and efficiency. Second, because the vehicle is required to move after the main power source has been removed, the vehicle requires an auxiliary power source to power the vehicle during this period. Having to provide an auxiliary power source increases costs, reduces space within the vehicle, and increases the complexity of the vehicle's circuitry and control systems.

WO2019092029 discloses a system in which a single charging station assembly contains multiple vertically arranged charging stations that can vertically move on the assembly. This allows a vehicle to interact with a single charging station assembly to exchange a power source. However, the vehicle is still required to horizontally move towards and away from the charging station assembly to fully complete a power source exchange and therefore the system of WO2019092029 has the same disadvantages as the system of WO2015104263 described above.

There is therefore a need for a load handling device and storage system that decreases the downtime of the load handling device in an efficient manner.

### SUMMARY OF INVENTION

The invention is defined in the accompanying claims.

### Load Handling Device

A load handling device is provided for lifting and moving containers arranged in stacks in a storage structure comprising a track structure. The track structure comprises a first set of tracks and a second set of tracks, the first set of tracks extending in a first direction and the second set of tracks extending in a second direction, the second direction being substantially perpendicular to the first direction to form a grid pattern defining a plurality of grid cells above the stacks of containers. The load handling device comprises:
a driving assembly configured to horizontally move the load handling device on the track structure;
a lifting mechanism configured lift a container from a stack;
a power source; and
an externally accessible power source compartment configured to electrically couple to the power source, wherein the power source compartment is further configured to removably receive the power source in a vertical direction.

By providing a power source compartment that allows the power source to be inserted and removed in a vertical direction, the load handling device is provided with at least the following advantages, particularly over load handling devices, such as those described in the background section, in which the power source is exchanged in a horizontal direction:
The power source compartment is externally accessible and therefore the power source can be conveniently and efficiently exchanged without having to open the body load handling device. This also allows the power source to be exchanged while the load handling device remains on the track structure.
The load handling device is not required to present a particular side-face to exchange the power source, which provides flexibility as to how the load handing device is orientated on the track structure, and the location of peripheral equipment for exchanging the power source.
The load handling device is not required to move in a horizontal direction to exchange the power source, which frees up space on the track structure and does not require the load handling device to have an auxiliary power source to power a driving assembly after the power source has been removed.
The load handling device is not required to provide a horizontal reaction force (e.g. using a braking mechanism) to prevent the load handling device from moving when the power source is being inserted or removed because the reaction force is in the vertical direction and is provided by the track structure underneath the load handling device.

The power source may be a battery. The battery may be a rechargeable battery.

The power source compartment may be externally accessible from above the load handling device. The power source compartment may comprise a top-facing opening and the power source compartment may be configured to removably receive the power source in a downwards direction via the top-facing opening. In this way, insertion of the power source into the power source compartment and electrical coupling between the power source and the power source compartment is naturally aided by the weight of the power source and gravity.

The top-facing opening may be defined by an external body (e.g. an external casing) of the load handling device. The top-facing opening may be defined in an external top face or surface of the external body of the load handling device.

The power source compartment may comprise side walls that define the top-facing opening.

The top-facing opening may be at least partially defined by one or more locating surfaces that taper downwards towards the power source compartment. In this way, the power source does not need to be precisely aligned with the power source compartment when the power source is being inserted into the power source compartment. Alternatively or in addition, the bottom of the power source may comprise one or more tapered locating surfaces.

The power source compartment may be located fully within an external body (e.g. an external casing) of the load handling device such that the power source is fully located within the external body of the load handling device when received in the power source compartment. Alternatively, the power source compartment may only be partially located within the external body of the load handling device such that a portion of the power source protrudes out of the external body when received in the power source compartment. This may aid removal of the power source from the power source compartment due to a greater exposed surface area, and may free up space within the external body of the load handling device for other components. The power source compartment may alternatively be located on the external body of the load handling device, i.e. the power source compartment may be located external to the external body of the load handling device. For example, the power source compartment may be located on top of the external body.

The power source compartment may be at least partially defined by a bottom wall and/or one or more side walls. The power source compartment may fully or partially physically enclose the power source from the sides and the bottom. A side wall of the power source compartment may comprise a vertically extending groove shaped and configured to vertically receive a corresponding tongue (protrusion) on a side wall of the power source such that the power source is constrained from moving in a horizontal direction relative to the side wall. With this arrangement, the power source compartment can restrain horizontal movement of the power source without requiring the perimeter of the power source to be fully surrounded by side walls.

When electrically coupled to the power source compartment, the power source may provide power to one or more electrical or electronic components of the load handling device, e.g. the driving assembly and/or the lifting mechanism.

The power source compartment may be configured to electrically couple to the power source when the power source is vertically received into the power source compartment and electrically uncouple from the power source when the power source is vertically removed from the power source compartment. In other words, the action of vertically inserting the power source into the power source compartment causes the power source to automatically electrically couple to the power source compartment.

The power source compartment may comprise an electrical connector configured to electrically couple to a corresponding electrical connector of the power source when the power source is vertically received into the power source compartment and electrically uncouple from the electrical connector of the power source when the power source is vertically removed out of the power source compartment. The electrical connector of the power source compartment may comprise a male connector and the electrical connector of the power source may comprise a female connector or vice versa. The electrical connectors may alternatively comprise electrical contacts.

The electrical connectors of the power source compartment and the power source may face in opposing vertical directions. The electrical connector of the power source compartment may be upward-facing and the electrical connector of the power source may be downward-facing. The upward-facing electrical connector of the power source compartment may be provided on a bottom wall of the power source compartment and the downward-facing electrical connector of the power source may be provided on a bottom wall of the power source.

Alternatively, the electrical connectors of the power source compartment and the power source may face in opposing horizontal directions. The electrical connectors may be provided on opposing side walls of the power source compartment and the power source. The electrical connector of the power source compartment and/or the electrical connector of the power source may be biased in a horizontal direction such that the electrical connectors contact each other when the power source is inserted into the power source compartment.

The load handling device may further comprise a locking mechanism configured to releasably lock the power source in the power source compartment. The locking mechanism helps to keep the power source within the power source compartment when the load handling device is moving or if the load handling device falls over.

The power source compartment may comprise a first locking member located on/in the power source compartment or on the power source, and a second locking member located on the power source or on/in the power source compartment respectively, wherein the first locking member is configured to move between a locking position in which the first locking member blocks the second locking member in a vertical direction to prevent the power source from moving vertically out of the power source compartment, and a release position in which the power source is free to move vertically out of the power source compartment.

The first and second locking members may comprise vertically-facing blocking surfaces configured to directly oppose each other in the vertical direction when the first locking member is in the locking position. For example, the locking member of the power source compartment may comprise a downward-facing blocking surface and the locking member of the power source may comprise an upward-facing blocking surface configured to engage when the first locking member is in the locking position to prevent the power source from being vertically lifted out of the power source compartment.

The first locking member may comprise a protrusion (e.g. a pin, bar, hook, etc.) and the second locking member may comprise a recess or a protrusion (e.g. a rim, rib, etc.). The second locking member may be a top surface of the power source.

The first locking member may be configured to move linearly (e.g. in a horizontal direction) between the locking position and the release position. Alternatively, the first locking member may be pivotally mounted and configured to pivotally rotate between the locking position and the release position.

The locking mechanism may comprise an actuator (e.g. an electric actuator) configured to selectively engage and/or disengage the first and second locking members.

The locking mechanism may be configured such that vertical insertion of the power source into the power source compartment automatically locks the power source in the power source compartment, e.g. by a mechanical locking mechanism.

The first locking member may be biased towards the locking position. For example, the first locking member may be biased by a spring, or the first locking member may be made from a resilient material that returns to the locking position after being deformed towards the release position. A surface of the first and/or second locking member may have a geometry (e.g. a tapered surface) such that vertical insertion of the power source into the power source compartment causes the second locking member to engage and move the first locking member against the biasing force towards the release position until the second locking member has moved vertically past the first locking member.

The locking mechanism may comprise a release mechanism configured to move the first locking member against the biasing force to the release position when activated. For example, the release mechanism may comprise a release member mechanically linked to the first locking member and configured to move the first locking member against the biasing force towards the release position. For example, the release member may comprise a button configured to move the first locking member to the release position when the button is held down and allow the first locking member to return to the locking position under the biasing force when the button is released.

The locking mechanism may be configured to lock the power source in the power source compartment when the power source is rotated about a vertical axis in a first direction relative to the power source compartment and release the power source from the power source compartment when the power source is rotated about the vertical axis in a second direction opposite to the first direction relative to the power source compartment. For example, the locking mechanism may comprise a threaded coupling or a bayonet coupling.

The locking mechanism may be configured to magnetically couple the power source and the power source compartment. For example, the power source compartment may comprise an electromagnet and the power source may comprise a ferromagnetic portion or vice versa, wherein activating the electromagnet prevents the power source from being vertically removed from the power source compartment, and deactivating the electromagnet allows the power source to be vertically removed from the power source compartment.

The power source may comprise a cylindrical outer casing having a longitudinal axis and the power source compartment may be configured to receive the power source such that the longitudinal axis is vertically orientated. The power source compartment may have a corresponding cylindrical shape. A cylindrical power source may be advantageous in that the power source can be vertically received in the power source compartment regardless of the angular orientation of the power source about the vertical axis. A cylindrical outer casing may also facilitate rotation of the power source relative to the power source compartment for the rotation locking mechanisms mentioned above.

The load handling device may comprise a container-receiving space for receiving a container lifted by the lifting mechanism, and the power source compartment may be located above the container-receiving space. The load handling device may comprise a body comprising a lower portion and an upper portion arranged above the lower portion. The lower portion may house the container-receiving space. The upper portion may at least partially house the power source compartment. The upper portion may also house other components such as components of the lifting mechanism (e.g. motors) and/or wireless communication components.

The lifting mechanism may comprise a gripping device configured to releasably grip a container. The lifting mechanism may be configured to raise and lower the gripping device relative to the load handling device.

### Storage and Retrieval System

A storage and retrieval system is provided, comprising:
a storage structure comprising a track structure, the track structure comprising a first set of tracks and a second set of tracks, the first set of tracks extending in a first direction and the second set of tracks extending in a second direction, the second direction being substantially perpendicular to the first direction to form a grid pattern defining a plurality of grid cells;
a plurality of stacks of containers arranged within the storage structure, each stack being arranged below a grid cell;
a load handling device as defined above configured to move horizontally on the track structure; and
a power source exchanging apparatus comprising an end effector configured to releasably hold the power source and move vertically relative to the load handling device to vertically remove the power source from and/or vertically insert the power source into the power source compartment.

The end effector may be further configured to move horizontally relative to the load handling device. The end effector may be further configured to rotate about a vertical axis. The end effector may be further configured to rotate about a horizontal axis.

The power source exchanging apparatus may comprise a base located on or adjacent to the track structure and the end effector may be moveable relative to the base.

The base may be horizontally moveable relative to the track structure. This allows the power source exchanging apparatus to exchange the power source of a load handling device at more than one location on the track structure. For example, the base may be moveable on a platform adjacent to the outer perimeter of the track structure, or the base may be moveable on the track structure.

The base may be fixed with respect to the track structure. For example, the base may be fixed on a platform adjacent to the outer perimeter of the track structure, or the base may be fixed on the track structure, e.g. on a grid cell.

The power source exchanging apparatus may comprise a frame mounted directly above at least a portion of the track structure, and the end effector may be supported above the track structure by the frame.

The frame may comprise a horizontal beam and the end effector may be configured to move horizontally along the horizontal beam. The horizontal beam may be mounted above a row of grid cells. The horizontal beam may comprise a carriage horizontally moveable along the horizontal beam, the carriage may support the end effector and the end effector may be configured to move vertically relative to the carriage.

The horizontal beam may be supported above the track structure by downwardly extending legs at opposing ends of the horizontal beam. The legs may be fixed relative to the track structure. Alternatively, the legs may be movable relative to the track structure in a horizontal direction perpendicular to the longitudinal axis of the horizontal beam. This allows the horizontal beam to move above a plurality of rows of grid cells.

Instead of supporting legs, the horizontal beam may be supported between two opposing walls, or supported from a ceiling of a building or other structure surrounding the framework. The horizontal beam may be moveable in a horizontal direction perpendicular to the longitudinal axis of the beam. For example, the horizontal beam may be mounted between two opposing rails for movement along the opposing rails. This allows the horizontal beam to move above a plurality of rows of grid cells.

The end effector may be selectively moveable between a holding position for holding the power source and a release position for releasing the power source. For example, the end effector may be in the form of a gripper comprising two or more gripping members configured to move towards and away from each other to grip and release the power source.

The end effector may be configured to remove the power source from and/or insert the power source into the power source compartment when the load handling device is at any one of a plurality of designated grid cells. In other words, the power source exchanging apparatus may be configured to move the end effector to any one of a plurality of designated grid cells to allow the end effector to remove the power source from and/or insert the power source into the power source compartment when the load handling device is at any one of the plurality of designated grid cells. This allows the power source exchanging apparatus to continue operating even if a load handling device has malfunctioned and is blocking one of the designated grid cells.

The power source may comprise a ferromagnetic portion and the end effector may comprise an electromagnet for releasably holding the power source via the ferromagnetic portion.

The power source exchanging apparatus may be a robotic arm. The robotic arm may be a single axis robotic arm, 2-, 3-, 4-, 5- or 6-axis robotic arm, or a greater-than-6-axis robotic arm. The robotic arm may be an articulated robotic arm. The robotic arm may be a gantry or Cartesian robot.

The power source exchanging apparatus may comprises a first end effector configured, in use, to vertically remove a power source from the power source compartment of the load handling device and a second end effector configured, in use, to vertically insert a power source into the power source compartment of said load handling device.

The storage and retrieval system may further comprise a power source storage station comprising at least one power source holder configured to receive the power source. The power source exchanging apparatus may be configured, in use, to move the power source between the load handling device and the power source storage station. For example, the power source exchanging apparatus may be configured to move a depleted power source from the power source compartment of the load handling device to a power source holder of the power source storage station and move a replacement power source from a power source holder of the power source storage station to the power source compartment of the load handling device.

The power source may be a rechargeable power source and the power source holder may be configured to charge the rechargeable power source when received in the power source holder.

The power source holder may be configured to removably receive the power source in a horizontal direction. The end effector may be configured to orientate the power source about a horizontal axis between a vertical orientation for insertion or removal from the power source compartment, and a horizontal orientation for insertion or removal from the power source holder.

The power source holder may be configured to removably receive the power source in a vertical direction, e.g. from above. The power source storage station may be configured to move the power source holder between a presentation position in which the power source holder is accessible to the end effector from above (to allow the power source holder to removably receive the power source in a vertical direction from above), and a storage position in which the power source holder is not accessible to the end effector from above.

The power source holder may be configured to move horizontally between the storage position and the presentation position.

The power source holder may be configured to move vertically between the storage position and the presentation position. For example, the power source storage station may comprise a vertical carousel on which the power source holder is arranged and the vertical carousel may be configured to rotate about a horizontal axis to selectively move the power source between the presentation position and the storage position.

The power source storage station may be located on or adjacent to the track structure. For example, the power source storage station may be located on a platform adjacent to the outer perimeter of the track structure, or located on one or more grid cells of the track structure.

The power source storage station may have a rear side facing away from the track structure. The power source holder may be accessible from the rear side to allow a power source to be inserted into or removed from the power source holder from the rear side of the power source station. This allows a power source to be removed from the power source storage station by a human worker (e.g. for maintenance) without the worker having to be located in an area with potentially dangerous equipment (e.g. the track structure, the load handling device, the power source exchanging apparatus, etc.), or without having to shut down the potentially dangerous equipment.

The power source storage station may comprise a plurality of power source holders, each configured to receive a power source. The power source holders may be vertically arranged in a single column, or vertically arranged in a plurality of horizontally adjacent columns, or arranged in a horizontal plane.

The power source exchanging apparatus may be mounted on the power source storage station, or at a location adjacent to the power source storage station, e.g. between the power source storage station and the track structure.

### Method of Exchanging a Power Source in a Load Handling Device

A method of exchanging the power source in the power source compartment of the load handling device defined above or the load handling device of the storage and retrieval system defined above is provided. The method comprises the steps of:
(i) vertically removing a first power source from the power source compartment; and
(ii) vertically inserting a second power source into the power source compartment.

The load handling device may remain stationary in at least a horizontal direction (e.g. on the same grid cell of the track structure) from when the first power source is removed to when the second power source is inserted.

### BRIEF DESCRIPTION OF THE DRAWINGS

The present invention will now be described, by way of example only, with reference to the accompanying drawings, in which like reference numerals are used for like features, and in which:

FIG. 1 is a schematic perspective view of a grid storage structure and containers.

FIG. 2 is a schematic plan view of a track on top of the storage structure of FIG. 1.

FIG. 3 shows load handling devices on top of the storage structure of FIG. 1.

FIG. 4 is a schematic perspective view of a single load handling device with a lifting mechanism in a lowered configuration.

FIG. 5 shows schematic cutaway views of the load handling device of FIG. 4 with the lifting mechanism in a raised and a lowered configuration.

FIG. 6A is a schematic perspective view of a load handling device with an external side wall removed, showing a power source in a power source compartment.

FIG. 6B is a schematic cross-sectional side view of the load handling device of FIG. 6A.

FIG. 7A is a schematic perspective view of another load handling device with an external side wall removed, showing a power source in a power source compartment.

FIG. 7B is a schematic cross-sectional side view of the load handling device of FIG. 7A.

FIG. 8 is a schematic perspective view of a power source and a power source compartment on top of a load handling device.

FIG. 9 is a schematic perspective view of a power source exchanging apparatus located adjacent to a track structure.

FIG. 10 is a schematic perspective view of another power source exchanging apparatus located above a track structure.

FIG. 11A is a schematic cross-sectional view of a locking mechanism for releasably locking a power source in a power source compartment.

FIG. 11B is a schematic cross-sectional view of another locking mechanism for releasably locking a power source in a power source compartment.

FIG. 11C is a schematic cross-sectional view of another locking mechanism for releasably locking a power source in a power source compartment.

FIG. 11D is a schematic cross-sectional view of another locking mechanism for releasably locking a power source in a power source compartment.

FIG. 12A is a schematic perspective view of a first example power source storage station for storing power sources.

FIG. 12B is a schematic perspective view of a second example power source storage station for storing power sources.

FIG. 12C is a schematic perspective view of a third example power source storage station for storing power sources.

FIG. 12D is a schematic perspective view of a fourth example power source storage station for storing power sources.

FIG. 12E is a schematic perspective view of a power source exchanging apparatus mounted on top of the fourth power source storage station.

FIG. 13 is a schematic perspective view of an external body of a load handling device with an open frame structure.

### DETAILED DESCRIPTION

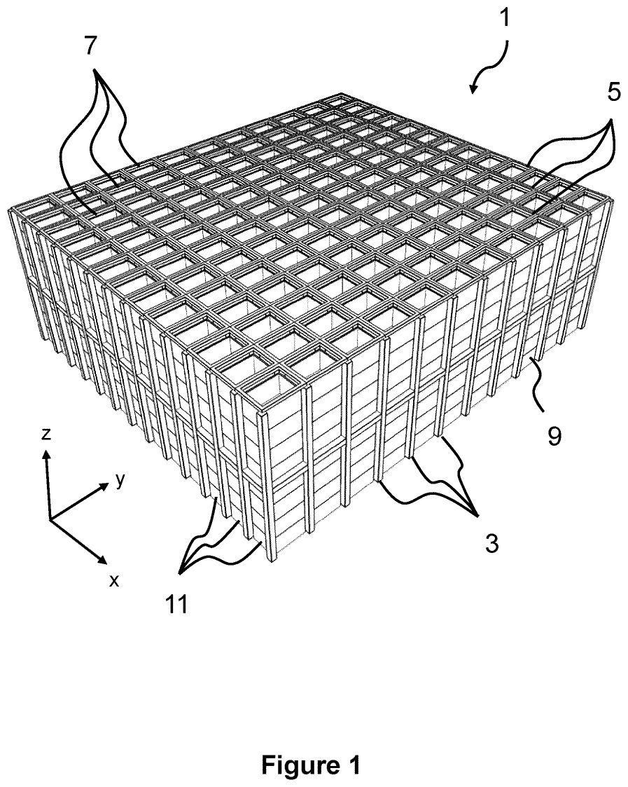

FIG. 1 illustrates a storage structure 1 of a storage and retrieval system. The storage structure 1 comprises a framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14. In the illustrated example, storage containers 9 are arranged in stacks 11 beneath the grid cells 14 defined by the grid pattern, one stack 11 of containers 9 per grid cell 14.

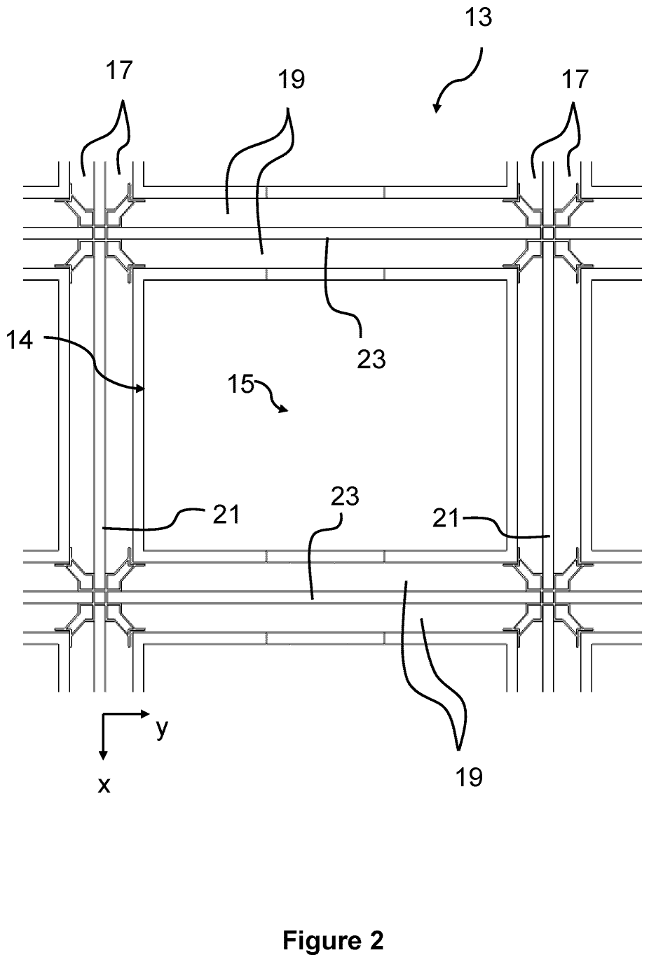

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells 14. The apertures 15 are sized to allow containers 9 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible.

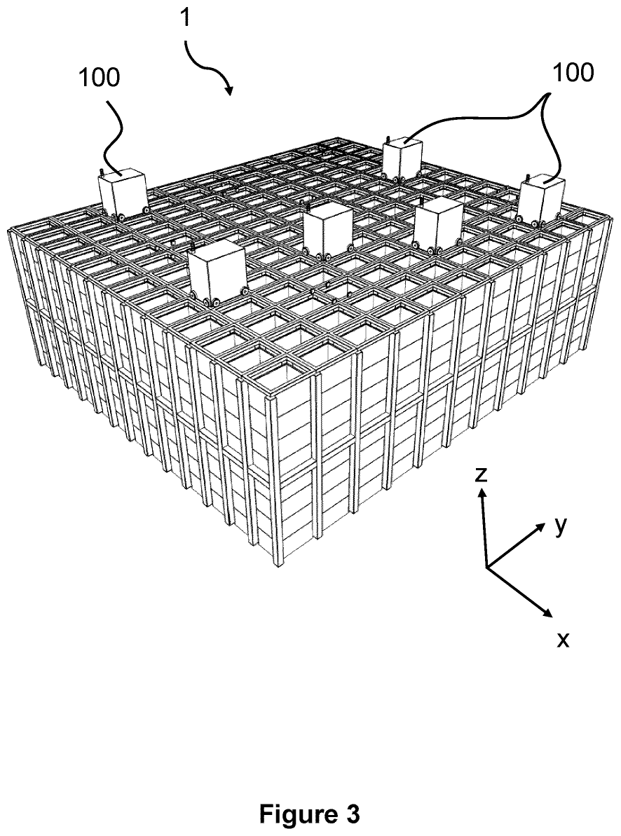

FIG. 3 shows a plurality of load handling devices 100 moving on top of the storage structure 1 illustrated in FIG. 1. The load handling devices 100, which may also be referred to as robots or bots, are provided with sets of wheels to engage with corresponding x- or y-direction tracks 17, 19 to enable the bots 100 to travel across the track structure 13 and reach specific grid cells 14. The illustrated pairs of tracks 17, 19 separated by channels 21, 23 allow bots 100 to occupy (or pass one another on) neighbouring grid cells 14 without colliding with one another.

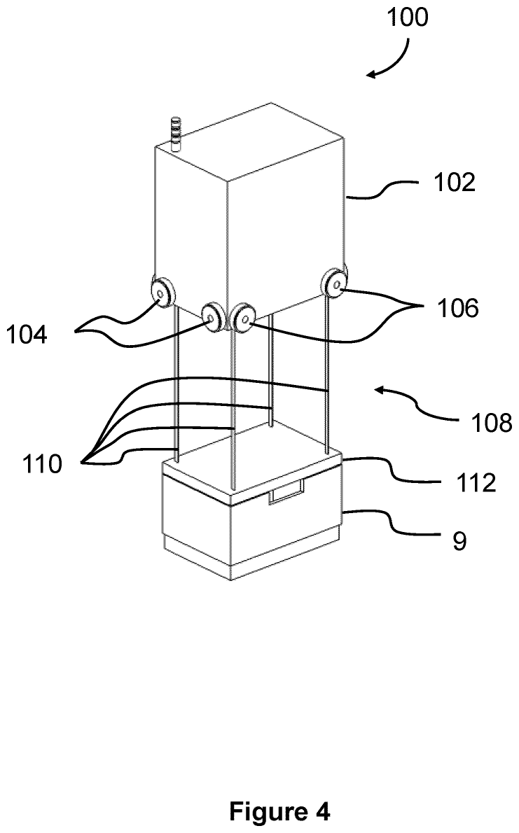

As illustrated in FIG. 4, a bot 100 comprises a body 102 in or on which are mounted one or more components which enable the bot 100 to perform its intended functions. These functions may include moving across the storage structure 1 on the track structure 13 and raising or lowering containers 9 (e.g. from or to stacks 11) so that the bot 100 can retrieve or deposit containers 9 in specific locations defined by the grid pattern.

The illustrated bot 100 comprises a driving assembly comprising first and second sets of wheels 104, 106 which are mounted on the body 102 of the bot 100 and enable the bot 100 to move in the x- and y-directions along the tracks 17 and 19, respectively. In particular, two wheels 104 are provided on the shorter side of the bot 100 visible in FIG. 4, and a further two wheels 104 are provided on the opposite shorter side of the bot 100. The wheels 104 engage with tracks 17 and are rotatably mounted on the body 102 of the bot 100 to allow the bot 100 to move along the tracks 17. Analogously, two wheels 106 are provided on the longer side of the bot 100 visible in FIG. 4, and a further two wheels 106 are provided on the opposite longer side of the bot 100. The wheels 106 engage with tracks 19 and are rotatably mounted on the body 102 of the bot 100 to allow the bot 100 to move along the tracks 19.

The bot 100 also comprises a lifting mechanism 108 configured to raise and lower containers 9. The illustrated lifting mechanism 108 comprises four tethers 110 which are connected at their lower ends to a gripping device 112. The tethers 110 may be in the form of cables, ropes, tapes, or any other form of tether with the necessary physical properties to lift the containers 9. The gripping device 112 comprises a gripping mechanism configured to engage with features of the containers 9. For example, the containers 9 may be provided with one or more apertures in their upper sides with which the gripping mechanism can engage. Alternatively or additionally, the gripping mechanism may be configured to hook under the rims or lips of the containers 9, and/or to clamp or grasp the containers 9. The tethers 110 may be wound up or down to raise or lower the gripping device 112, as required. One or more motors or other means may be provided to effect or control the winding up or down of the tethers 110.

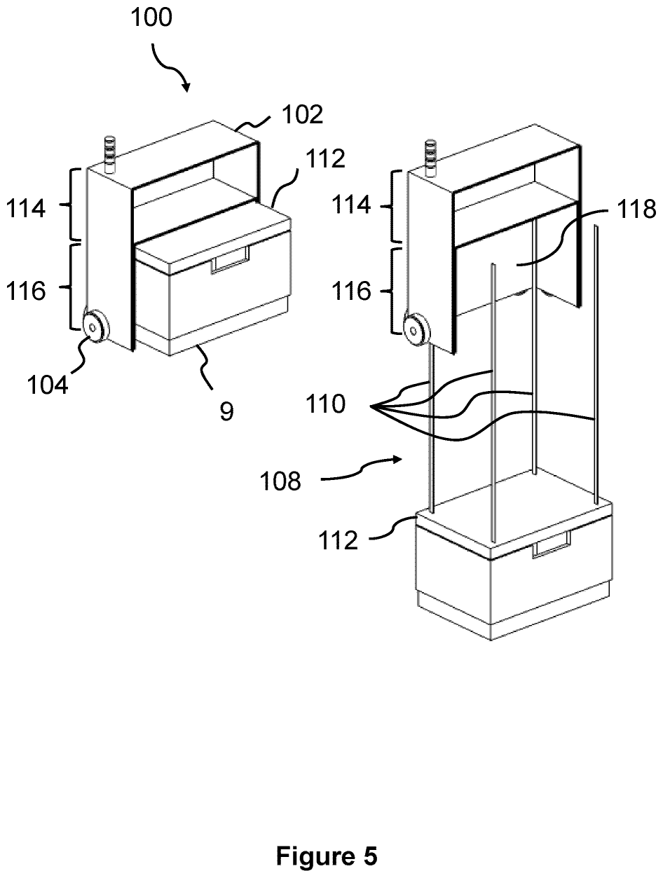

As can be seen in FIG. 5, the body 102 of the illustrated bot 100 has an upper portion 114 and a lower portion 116. The upper portion 114 is configured to house one or more operation components (not shown), such as components (e.g. motors) of the lifting mechanism, wireless communication components, etc. The lower portion 116 is arranged beneath the upper portion 114. The lower portion 116 comprises a container-receiving space or cavity 118 for accommodating at least part of a container 9 that has been raised by the lifting mechanism 108. The container-receiving space 118 is sized such that enough of a container 9 can fit inside the cavity to enable the bot 100 to move across the track structure 13 on top of storage structure 1 without the underside of the container 9 catching on the track structure 13 or another part of the storage structure 1. When the bot 100 has reached its intended destination, the lifting mechanism 108 controls the tethers 110 to lower the gripping device 112 and the corresponding container 9 out of the cavity and into the intended position. The intended position may be a stack 11 of containers 9 or an egress point of the storage structure 1 (or an ingress point of the storage structure 1 if the bot 100 has moved to collect a container 9 for storage in the storage structure 1). Although in the illustrated example the upper and lower portions 114, 116 are separated by a physical divider, in other examples, the upper and lower portions 114, 116 may not be physically divided by a specific component or part of the body 102 of the bot 100.

The container-receiving space 118 of the bot 100 may not be within the body 102 of the bot 100. For example, the container-receiving space 118 may instead be adjacent to the body 102 of the bot 100, e.g. in a cantilever arrangement with the weight of the body 102 of the bot 100 counterbalancing the weight of the container to be lifted. In such embodiments, a frame or arms of the lifting mechanism 108 may protrude horizontally from the body 102 of the bot 100, and the tethers 110 may be arranged at respective locations on the protruding frame/arms and configured to be raised and lowered from those locations to raise and lower a container into the container-receiving space 118 adjacent to the body 102. The height at which the frame/arms is/are mounted on and protrude(s) from the body 102 of the bot 100 may be chosen to provide a desired effect. For example, it may be preferable for the frame/arms to protrude at a high level on the body 102 of the bot 100 to allow a larger container (or a plurality of containers) to be raised into the container-receiving space 118 beneath the frame/arms. Alternatively, the frame/arms may be arranged to protrude lower down the body 102 (but still high enough to accommodate at least one container between the frame/arms and the track structure 13) to keep the centre of mass of the bot 100 lower when the bot 100 is loaded with a container.

To enable the bot 100 to move on the different wheels 104, 106 in the first and second directions, the driving assembly further comprises a wheel-positioning mechanism for selectively engaging either the first set of wheels 104 with the first set of tracks 17 or the second set of wheels 106 with the second set of tracks 19. The wheel-positioning mechanism is configured to raise and lower the first set of wheels 104 and/or the second set of wheels 106 relative to the body 102, thereby enabling the load handling device 100 to selectively move in either the first direction or the second direction across the tracks 17, 19 of the storage structure 1.

The wheel-positioning mechanism may include one or more linear actuators, rotary components or other means for raising and lowering at least one set of wheels 104, 106 relative to the body 102 of the bot 100 to bring the at least one set of wheels 104, 106 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 102 of the bot 100 stays substantially at the same height and therefore the weight of the body 102 and the components mounted thereon does not need to be lifted and lowered by the wheel-positioning mechanism.

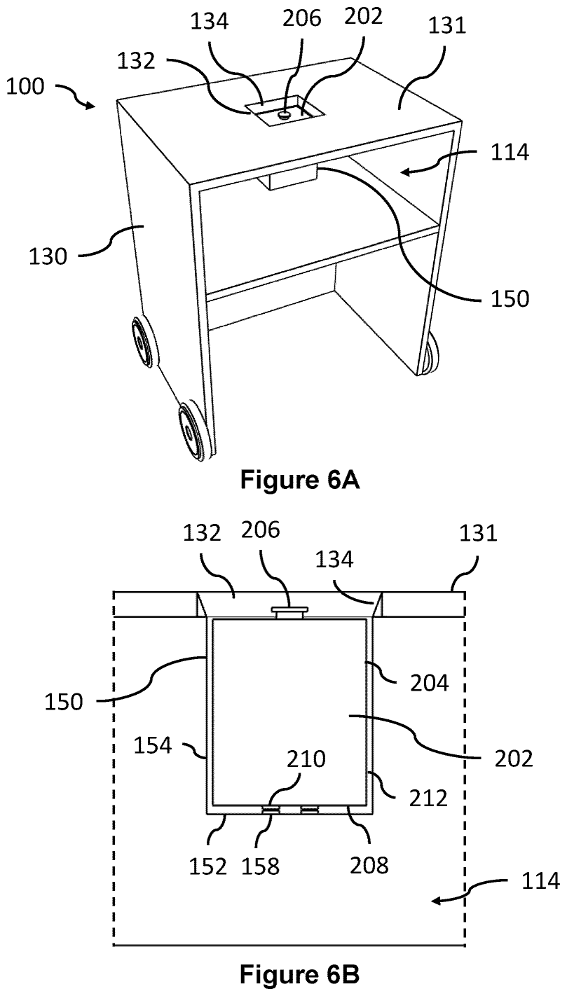

As illustrated in FIGS. 6A and 6B, the bot 100 further comprises a power source 202. FIG. 6A is a perspective view of the bot 100 with an exterior side wall removed so that the interior of the bot 100 is visible. FIG. 6B is a partial cross-sectional side view of the bot 100. Some of the bot components described above (e.g. the lifting mechanism) have been omitted from these figures and subsequent figures for clarity.

The power source 202 provides power to one or more electrical components of the bot 100, such as the lifting mechanism and/or the driving assembly. The power source 202 may be a battery or any other type of suitable power source for delivering electric power, such as a supercapacitor. The power source 202 comprises an outer casing 204. The outer casing 204 is depicted as having a cuboidal shape but may have other shapes, such as a cylindrical shape. To facilitate handling of the power source 202 by a human hand or robotic end effector, the outer casing 204 may comprise one or more gripping features 206, e.g. protrusions and/or recesses. The power source 202 is preferably a rechargeable power source but may also be a single-use power source.

The bot 100 further comprises an externally accessible power source compartment 150, i.e. it can be accessed from outside the body of the load handling device. The power source compartment 150 is configured to removably receive the power source 202 in a vertical direction. In this illustrated example, the power source compartment 150 is fully located within the upper portion of the body of the bot 100 such that the power source 202 is fully received within the body of the bot 100. In this illustrated example, the power source compartment 150 is defined by side walls 154 and a bottom wall 152 configured to separate the power source 202 from other components inside the upper portion of the bot 100. However, the power source compartment 150 may be only partially defined by side walls and/or a bottom wall, or the power source compartment 150 may simply be a reserved space in which the power source 202 can reside. The bottom of the power source compartment 150 may also be defined by a wall physically dividing the upper portion and the lower portion of the bot 100 and one or more sides of the power source compartment 154 may be defined by an external casing 130 of the bot 100.

The power source compartment 150 is shown as being centred horizontally with respect to the bot 100, which helps the bot 100 to maintain balance when moving with a power source 202 in the power source compartment 150, but the power source compartment 150 could also be located elsewhere, e.g. towards one horizontal side of the bot 100.

The power source compartment 150 further comprises a top-facing opening 132, which in this example is defined in a top surface 131 of the external casing 130 of the body 102. The top-facing opening 132 is dimensioned such that the power source compartment 150 can receive the power source 202 in a vertical direction via the top-facing opening 132. The top-facing opening 132 optionally comprises one or more locating surfaces 134 tapering downwards towards the power source compartment 150 for guiding the power source 202 with the power source compartment 150. By providing the locating surfaces 134, the power source 202 does not need to be precisely aligned with the power source compartment 150 when the power source 202 is being inserted into the power source compartment 150. Alternatively or in addition, the bottom of the power source casing 204 may comprise one or more tapered surfaces for the same purpose.

The power source 202 is electrically coupled to the power source compartment 150 via one or more electrical connectors 210 on the power source casing 204 and one or more electrical connectors 158 in the power source compartment 150. The electrical connectors 158, 210 are configured to connect when the power source 202 is vertically received in the power source compartment 150 and disconnect when the power source 202 is vertically removed from the power source compartment 150. As shown in FIG. 6B, the electrical connectors 210 of the power source 202 are located on a downward-facing surface of the bottom wall 208 of the power source casing 204 and the electrical connectors 158 of the power source compartment 150 are located on an upward-facing surface of the bottom wall 152 of the power source compartment 150. However, the electrical connectors 158, 210 could be located on any vertically opposed surfaces of the power source casing 204 and the power source compartment 150 respectively. When the power source 202 is vertically inserted into the power source compartment 150, the bottom wall 208 of the power source casing 204 moves towards the bottom wall 152 of the power source compartment 150 until the electrical connectors 158, 210 are connected. The weight of the power source 202 helps the vertically-facing electrical connectors 158, 210 connect and remain connected. The electrical connectors may take any form of suitable electrical connector, such as male and female connectors (e.g. pins and corresponding sockets) or electrical contacts.

Alternatively, the electrical connectors 158, 210 may face in opposing horizontal directions. For example, the electrical contacts 158, 210 may be located on a side wall 154 of the power source compartment 150 and on a side wall 212 of the power source casing 204 and configured such that they couple when the power source 202 has been received in the power source compartment 150. For example, the electrical connectors 158 of the power source compartment 150 may be biased (e.g. spring-biased) towards the side wall 212 of the power source casing 204 and/or the electrical connectors of the power source 158, 210 may be biased towards the side wall 154 of the power source compartment 150.

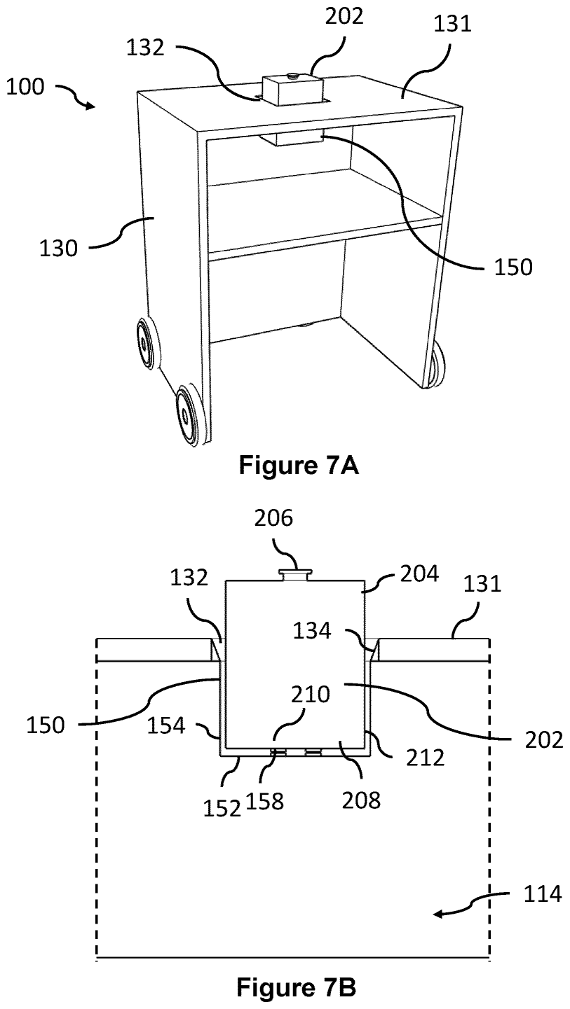

The power source compartment 150 does not need to be fully contained within the external casing 130 of the bot 100. For example, as shown in FIGS. 7A and 7B, the power source compartment 150 is only partially located within the external casing 130 of the bot 100 such that the power source 202 protrudes out of the external casing 130 of the bot 100 when received in the power source compartment 150. This may aid in manual or automated removal of the power source 202 from the power source compartment 150 due to a greater exposed surface area, and free up room inside the bot 100 for other components.

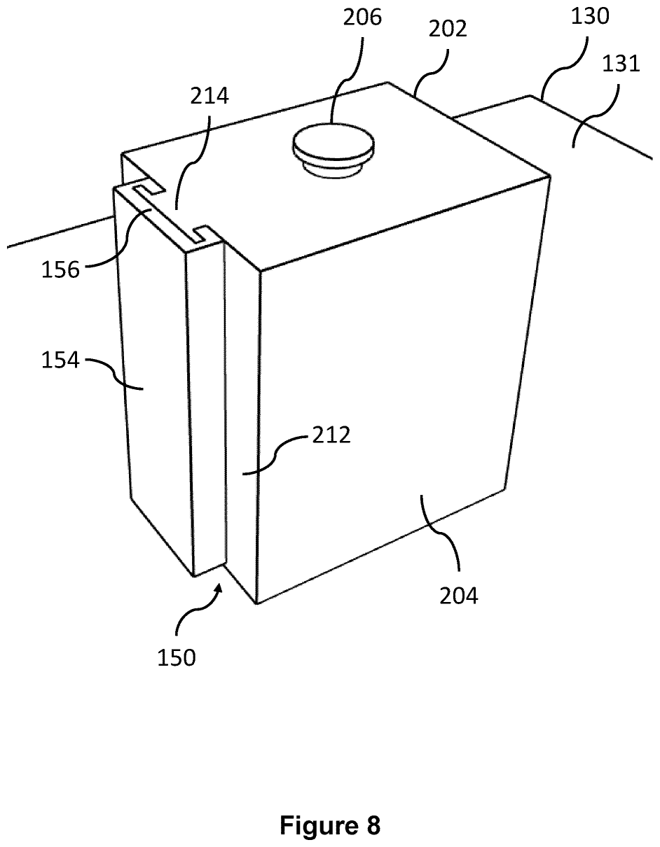

FIG. 8 shows an alternative example in which the whole power source compartment 150 is external to the external casing 130 of the bot 100. In this example, the power source compartment 150 is located on the top surface 131 of the external casing 130 of the bot 100. The power source compartment 150 is partially defined by a side wall 154. The side wall 154 comprises a vertically extending groove 156 shaped and configured to vertically receive a corresponding tongue 214 (i.e. a protrusion) on the side wall 212 of the power source casing 204 such that the power source 202 is constrained from moving in the horizontal direction relative to the power source compartment 150. In the illustrated example, the tongue 214 and groove 156 have a T-shaped profile, though other profiles are possible to achieve the same effect. In this way, the power source compartment 150 can restrain horizontal movement of the power source 202 without requiring side walls that fully enclose the perimeter of the power source 202.

During operation of the bot 100 on the track structure 13, the energy in the power source 202 will deplete until the near-depleted power source 202 needs to be exchanged for a replacement power source 202 to allow the bot 100 to continue operation on the track structure 13.

The power source 202 may be exchanged manually, but a power source exchanging apparatus is preferably provided for convenience and efficiency, and to allow the power source 202 to be exchanged while the bot 100 remains on the track structure 13. The power source exchanging apparatus may be any form of suitable “pick and place” robot that can pick an object up and place it down in a desired location and in a desired manner.

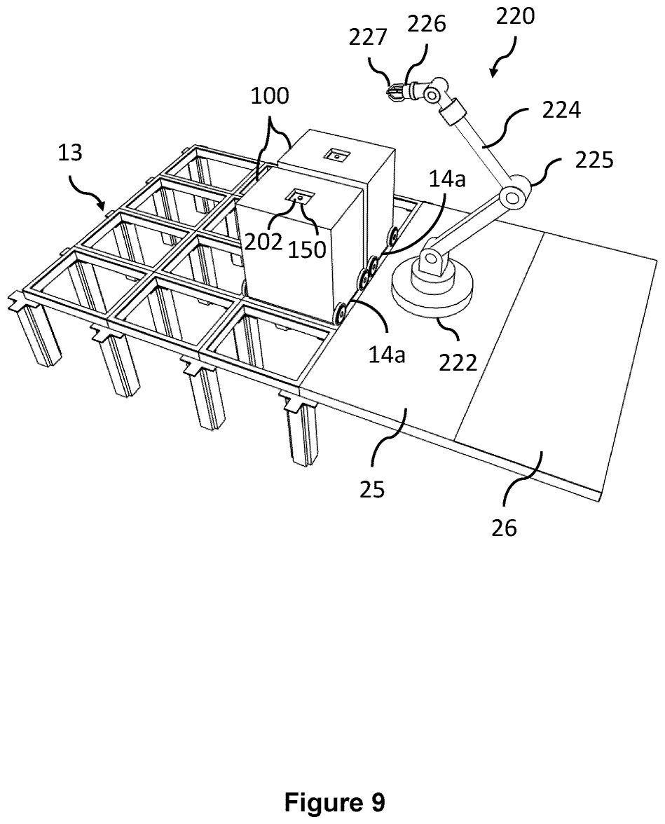

FIG. 9 shows an example power source exchanging apparatus in the form of a robotic arm 220 located on a platform 25 adjacent to the outer perimeter of a portion of the track structure 13. The robotic arm 220 comprises a base 222 at one end and an end effector 226 at the other end. The base 222 is fixed with respect to the track structure 13 by mounting it on the platform 25. The illustrated end effector 226 is in the form of a gripper for physically grasping the power source 202; however, the end effector 226 may take any form suitable for releasably holding the power source. The gripper 226 comprises a pair of gripping members 227 selectively moveable between a gripping position for holding the power source 202 and a release position for releasing the power source 202. The base 222 and the end effector 226 are connected by a series of linkages 224 and joints 225. The joints 225 are configured to give the robotic arm 220 the desired degrees of freedom to allow it to vertically remove a power source 202 from the power source compartment 150 and place it in a designated area 26, and/or to pick up a replacement power source 202 from a designated area 26 and vertically insert it into the power source compartment 150. In this illustrated example, the robotic arm 220 is a 6-axis robotic arm (i.e. the joints provide six degrees of freedom), which allows for relatively complex movements that provides flexibility with regard to the relative positioning between the bot 100, the robotic arm 220 and the designated area 26.

The robotic arm 220 is configured to exchange the power source 202 of a bot 100 that is located on a designated grid cell 14a adjacent to the robotic arm 220. Because vertical removal and insertion of the power source 202 do not require any horizontal movement of the bot 100, the bot 100 can remain on the designated grid cell 14a during the power source exchange, which includes the period for removing the depleted power source 202, the period for inserting the replacement power source 202, and the period in between.

Depending on the size and configuration of the robotic arm 220, the robotic arm 220 may be configured to interact with a bot 100 on any one of a plurality of designated grid cells 14a in the vicinity of the robotic arm 220. In other words, the end effector 226 of the robotic arm 220 may be movable to the power source compartments 150 of at least two bots that are in the vicinity of the robotic arm 220, as shown in FIG. 9. This allows the robotic arm 220 to continue performing power source exchanges even if a bot 100 malfunctions and blocks one of the designated grid cells 14a.

Instead of being located on a platform adjacent to the outer perimeter of the track structure 13, the robotic arm 220 may also be located on the track structure 13 itself, e.g. on a grid cell 14 of the track structure 13.

Instead of a single robotic arm 220 performing both power source removal and insertion operations, a first robotic arm 220 can be provided to remove a power source 202 from the power source compartment 150 and a second robotic arm 220 can be provided to insert a replacement power source 202 into the power source compartment 150. Such an arrangement can result in quicker and more efficient power source exchanges because a replacement power source 202 can be inserted into the power source compartment 150 immediately after the depleted power source 202 has been removed as there is no need to wait for the first robotic arm 220 to place the depleted battery down and pick up the replacement battery. The first robotic arm 220 and the second robotic arm 220 may be configured to perform their respective removal and insertion operations while the bot 100 remains on the same grid cell 14a.

The robotic arm 220 is not limited to having a base 222 fixed with respect to the track structure 13. Instead, the base 222 may be configured to move relative to the track structure 13. For example, the base 222 may comprise wheels or other driving means. This allows the robotic arm 220 to perform power source exchanges (removal and/or insertion) over a plurality of different grid cells 14 (e.g. a row of grid cells 14). The base 222 may be configured to move on the platform 25 adjacent to the outer perimeter of the track structure 13, or the base 222 may be configured to move on the tracks of the track structure 13 itself (e.g. in the X and/or Y direction).

The robotic arm 220 is not limited to being a 6-axis robotic arm. At a minimum, the robotic arm 220 comprises an end effector 226 that is vertically movable relative to the bot 100 to allow the robotic arm 220 to vertically remove and insert the power source 202. To provide more complex movements, the robotic arm 220 may comprise further degrees of freedom, e.g.

the robotic arm 220 may be a 2, 3, 4, or 5-axis robotic arm. The robotic arm 220 may also comprise more than six degrees of freedom, e.g. a 7-axis robotic arm.

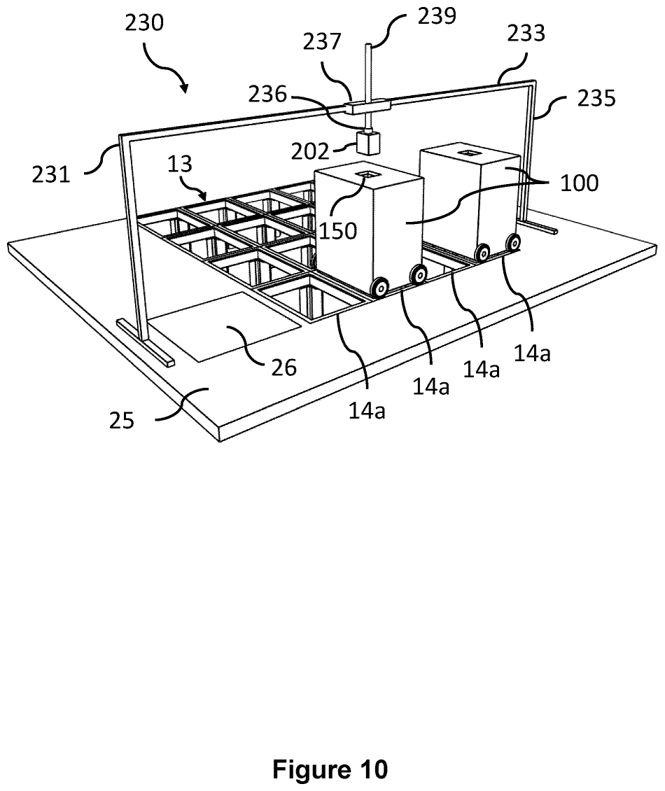

FIG. 10 shows another example power source exchanging apparatus in the form a robotic arm 230 mounted above the track structure 13. This robotic arm 230 is an example of a Cartesian robot, which is able to move three orthogonal directions. The robotic arm 230 comprises a gantry frame 231 which comprises a horizontal beam 233 supported by downwardly extending support legs 235 at opposing ends of the horizontal beam 233. The support legs 235 are fixed with respect to the track structure 13 and the frame 231 straddles at least one designated grid cell 14a of the track structure 13 so that the horizontal beam 233 is located directly above the designated grid cell 14a. In this illustrated example, the horizontal beam is located directly above a row of designated grid cells 14a. The robotic arm 230 further comprises a carriage 237 horizontally movable along the horizontal beam 233 and a vertical rod 239 supported by the carriage 237. The vertical rod 239 is vertically movable relative to the carriage 237 and comprises an end effector 236 mounted to the lower end of the rod 239.

In this illustrated example, the end effector 236 comprises an electromagnet and the power source 202 comprises a ferromagnetic portion to allow the power source 202 to be picked up by the electromagnet when activated and released when deactivated. However, the end effector 236 may comprise a gripper, similar to the end effector 226 in FIG. 9, or any other form of end effector suitable for releasably holding the power source 202.

To remove a depleted power source 202 from a bot 100 on a designated grid cell 14a, the carriage 237 moves along the horizontal beam 233 until the end effector 236 is positioned directly above the power source 202. The vertical rod 239 is then lowered until the end effector 236 can engage the power source 202. Once the power source 202 is engaged, the vertical rod 239 is raised so that the power source 202 is lifted out of the power source compartment 150. The power source 202 can then be moved horizontally and released in a designated area 26 for receiving depleted power sources 202.

To insert a replacement power source 202 into the bot 100, the end effector 236 picks up a replacement power source 202 from the designated area 26 (which may or may not be the same designated area for receiving power sources 202) and moves to a position directly above the bot 100 on the designated grid cell 14a. The end effector 236 is then lowered to insert the power source 202 into the power source compartment 150 and the power source 202 is released. The bot 100 can now use the power from the replacement power source 202 to drive off the designated grid cell 14a and continue its normal operations.

In alternative examples, the frame 231 may be moveable relative to the track structure 13. For example, the support legs 235 of the frame 231 may comprise wheels or other driving means. This allows the robotic arm 230 to perform power source exchanges across an area of designated grid cells 14a, rather than just a single row. The support legs 235 may be configured to move on the platform 25 adjacent to the outer perimeter of the track structure 13, or they may be configured to move on the track structure 13 itself.

In alternative examples, the horizontal beam 233 may be mounted between two opposing vertical walls or from the ceiling of a building or other structure that houses the storage structure instead of being mounted on support legs 235. The walls or ceiling may comprise rails between which the horizontal beam 233 is mounted to allow the horizontal beam 233 to move horizontally relative to the track structure 13.

In other examples, the horizontal beam 233 may support a first end effector 236 and a second end effector 236 independently movable along the horizontal beam 233. The first end effector 236 may be configured to remove a depleted power source 202 from the bot 100 and the second end effector 236 may be configured to insert a replacement power source 202 into the bot 100. The first end effector 236 may be configured to deliver depleted power sources 202 towards one end of the horizontal beam 233 and the second end effector 236 may be configured to deliver replacement power sources 202 from the opposing end of the horizontal beam 233. Alternatively, both the first and second end effectors may be configured to perform both insertion and removal operations.

In other examples, the robotic arm 230 may be configured to have a higher number of axes of movement. For example, the end effector 236 may be configured to rotate relative to the vertical rod 239. Furthermore, instead of a vertical rod 239 that is only moveable in a vertical direction, the carriage 237 may support a robotic arm configured to move in more directions, e.g. horizontally perpendicular to the horizontal beam 233.

The power source exchanging apparatus may comprise one or more sensors or vision systems as known in the art to allow the end effector to determine the position of the power source 202 and pick it up. Alternatively, the power source exchanging apparatus may be configured to perform predetermined movements to pick up the power source 202.

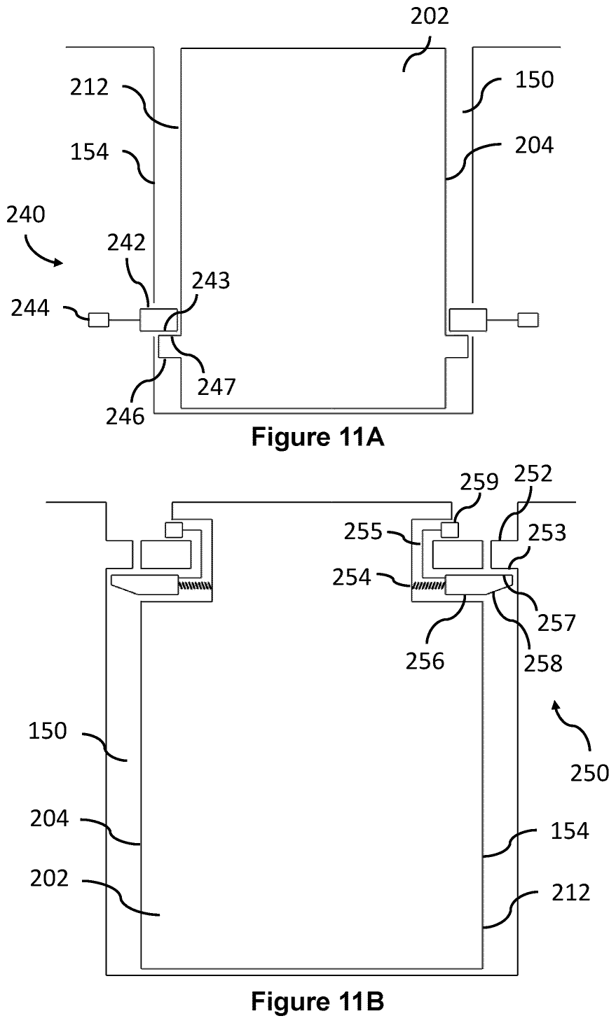

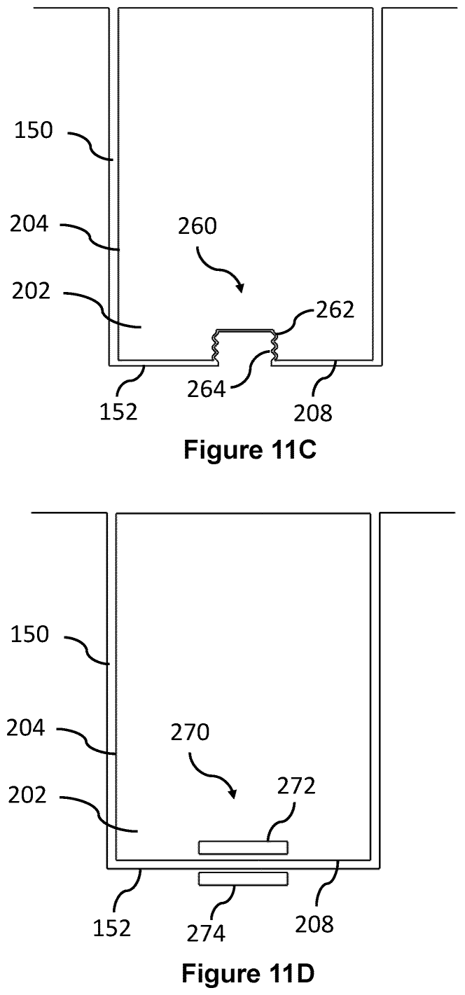

FIGS. 11A to 11D are schematic cross-sectional illustrations of the power source compartment 150 and the power source 202 showing examples of different locking mechanisms for releasably locking the power source 202 in the power source compartment 150. Although gravity may help the power source 202 stay in the power source compartment 150 to a certain extent, providing a locking mechanism may help to hold the power source 202 more securely in the power source compartment 150, particularly when the bot 100 is moving on the track structure 13 during operation.

FIG. 11A shows an example locking mechanism 240 in the form of a latching mechanism. A side wall 154 of the power source compartment 150 comprises a locking member 242 in the form of a horizontally extending pin. A side wall 212 of the power source casing 204 comprises a corresponding locking member 246 in the form of horizontally extending rib. The power source compartment 150 further comprises a linear actuator 244 configured to selectively move the pin 242 between an extended, locking position in which the pin 242 protrudes above the rib 246 to prevent the power source 202 from moving vertically out of the power source compartment 150 and a retracted, release position in which the pin 242 does not protrude above the rib 246 to allow the power source 202 to move vertically out of the power source compartment 150. In particular, the pin 242 provides a downward-facing blocking surface 243 and the rib 246 provides an upward-facing blocking surface 247 that directly oppose each other in the vertical direction when the pin 242 is in the locking position to prevent the power source 202 from being lifted out of the power source compartment 150.

The linear actuator 244 may be an electric actuator (e.g. a linear solenoid actuator) preferably configured to use power from the power source 202 when the power source 202 is electrically coupled to the power source compartment 150. The electric actuator may be a bi-stable actuator (e.g. a bi-stable linear solenoid actuator) to allow the pin to remain in the release position or the locking position without a continuous source of power.

As further shown in FIG. 11A, ribs 246 may be provided on opposing sides of the power source 202 and pins 242 may be provided on opposing sides of the power source compartment 150. This allows the power source 202 to be locked in the power source compartment 150 more securely.

FIG. 11B shows another example locking mechanism 250 in the form of a latching mechanism. In contrast to the locking mechanism 240 of FIG. 11A, the locking mechanism 250 of this example is configured to automatically lock the power source 202 in the power source compartment 150 when the power source 202 is vertically inserted into the power source compartment 150. The side wall 154 of the power source compartment 150 comprises a locking member 252 in the form of a horizontally extending rib and the power source casing 204 comprises a locking member 256 in the form of a horizontally extending pin that is biased horizontally outwards towards the locking position by a compression spring 254. The pin 256 has a downwards-facing tapered surface 258 configured such that downwards movement of the power source 202 into the power source compartment 150 causes the pin 256 to retract against the biasing force so that the rib 252 can be moved vertically past the pin 256. A tapered surface could alternatively or additionally be provided on the rib 252. Once the rib 252 has moved below the pin 256, the pin 256 can move outwards under the biasing force such that it extends above the rib 252. A downwards-facing blocking surface 253 of the rib 252 now directly opposes an upwards-facing blocking surface 257 of the pin 256, which blocks the power source 202 from being lifted out of the power source compartment 150.

To release the power source 202, the power source casing 204 comprises a release mechanism configured to move the pin 256 to the release position. In this illustrated example, the release mechanism comprises a release member 259 in the form of a button mechanically linked (represented by line 255) to the pin 256 such that when the button 259 is held down (in a horizontal direction in this illustrated example), the pin 256 is retracted against the biasing force. If removal of the power source 202 is to be carried out by the power source exchanging apparatus 220, 230 the end effector 226, 236 may be configured to hold down the button 259 when engaging the power source 202.

The release mechanism may take other forms. For example, instead of providing a release member 259 on the power source casing 204 for directly moving the pin 256 to the release position, the power source compartment 150 may comprise a release member (e.g. a button) mechanically linked to a release surface such that when the button is held down, the release surface pushes against the pin to retract the pin to the release position. As another example, the end effector 226, 236 may have a geometry, e.g. a tapered surface, configured to push the pin to the retracted position when the end effector engages the power source 202.

As further shown in FIG. 11B, ribs 252 may be provided on opposing sides of the power source compartment 150, and pins 256 and release members 259 may be provided on opposing sides of the power source casing 204 to lock the power source 202 in the power source compartment 150 more securely.

Other forms of a locking member biased towards the locking position are possible. For example, the locking mechanism may in the form of a snap fit mechanism where a locking member comprises a protrusion made from a resilient material (e.g. a plastic) that rests naturally in the locking position. The resilient material allows the protrusion to deform to the release position but is biased to return to the locking position.

It will be appreciated that instead of the linear latching mechanisms shown in FIGS. 11A and 11B, where a locking member is configured to move linearly between the locking position and the release position, the locking mechanism 240, 250 may instead comprise a rotational latching mechanism where a locking member (e.g. a hook) is pivotally mounted for pivotal rotation between the locking position and the release position. The pivotally mounted locking member may be selectively rotated between the locking position and the release position by a rotary actuator, or the pivotally mounted locking member may be biased towards the locking position (e.g. by a spring), in a similar manner to the examples of FIGS. 11A and 11B described above.

It will also be appreciated that the locking members 242, 246, 252, 256 do not need to be in the form of pins and ribs and can instead take other forms that provide vertically-facing blocking surfaces 243, 247 configured to directly oppose each other in the vertical direction to prevent the power source 202 from being vertically removed out of the power source compartment 150. Alternative example locking members include bars, hooks, recesses, rims, etc. The locking member of the power source 202 may simply be a top surface of the power source casing 204 and the power source compartment 150 may comprise a locking member configured to horizontally extend above the top surface of the power source casing 204.

FIG. 11C shows an alternative locking mechanism 260 in the form of a threaded coupling between the power source compartment 150 and the power source 202. In this illustrated example, the bottom wall 152 of the power source compartment 150 comprises a threaded portion 262 and the bottom wall 208 of the power source casing 204 comprises a corresponding threaded portion 264 configured to receive the threaded portion 262 of the power source compartment 202. Alternatively, the sidewalls 154, 212 of the power source compartment 150 and power source casing 204 could be threaded. To lock the power source 202 in the power source compartment 150, the power source 202 is rotated in one direction about a vertical axis to engage the threaded portions 262, 264, and to release the power source 202, the power source 202 is rotated in the opposite direction to disengage the threaded portions 262, 264. To allow the power source exchanging apparatus to lock and unlock the power source 202 in this example, the end effector may be configured to rotate about the vertical axis. To facilitate rotation of the power source 202 within the power source compartment 150, the power source 202 may have a cylindrical casing and the power source compartment 150 may have a corresponding cylindrical shape.

Instead of a threaded coupling, the locking mechanism may take other forms of rotational locking mechanisms such as a bayonet coupling, which is an example of a mechanism which requires the power source to be pushed downwards within the power source compartment before rotating the power source to lock or release the power source. This push-and-rotate movement of the power source could be carried out by the end effector of the power source exchanging apparatus.

FIG. 11D shows another locking mechanism 270 where the power source 202 and power source compartment 150 are magnetically coupled to lock the power source 202 in the power source compartment 150. The power source compartment 150 comprises an electromagnet 270 and the power source casing 204 comprises a ferromagnetic portion 272 or vice versa. The electromagnet 270 is activated to lock the power source 202 in the power source compartment 150 and deactivated to release the power source 202. The electromagnet 270 may be powered by the power source 202.

The locking mechanism is not limited to the examples shown in FIGS. 11A-11D and the locking mechanism can take any form of locking mechanism suitable for reversibly preventing the power source 202 from being vertically removed from the power source compartment 150. It will be appreciated that components of the locking mechanism (including the release mechanism) in the above examples which are described as being located in the power source compartment 150 can instead be located on the power source casing 202 and vice versa.

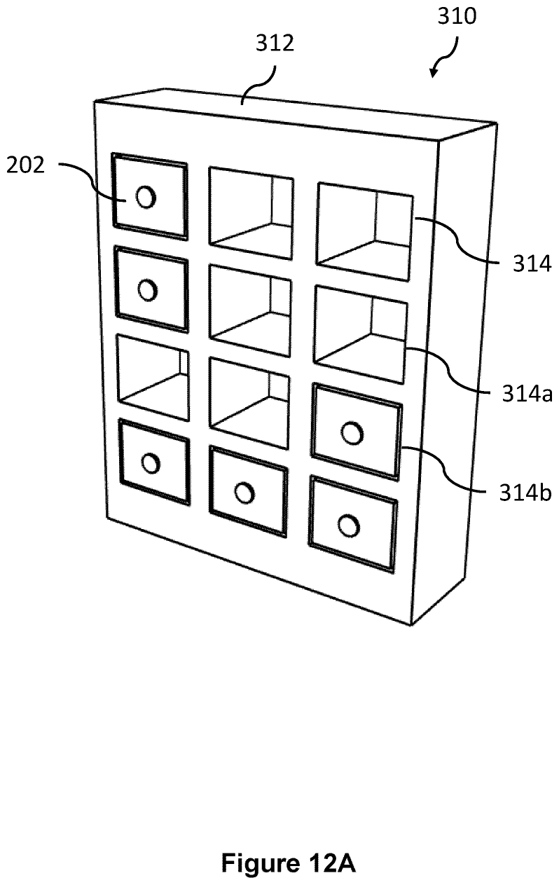

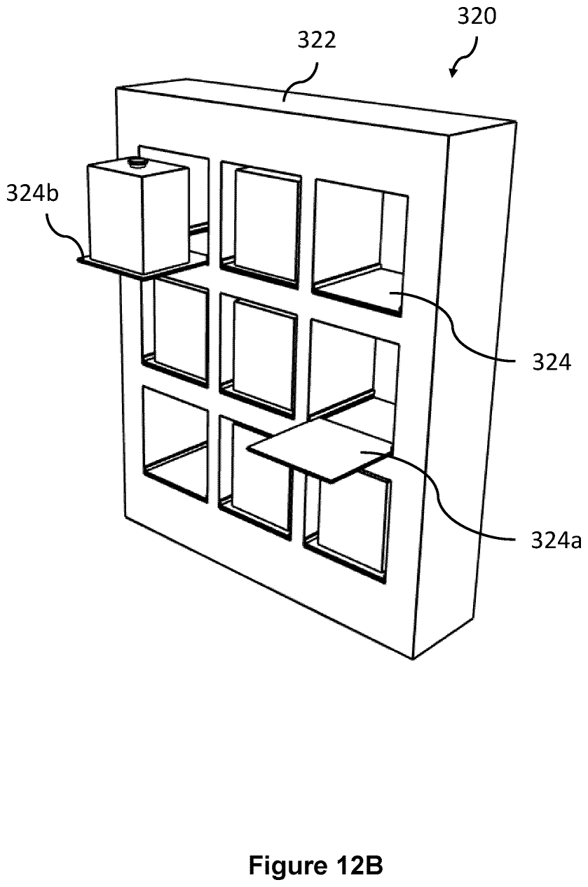

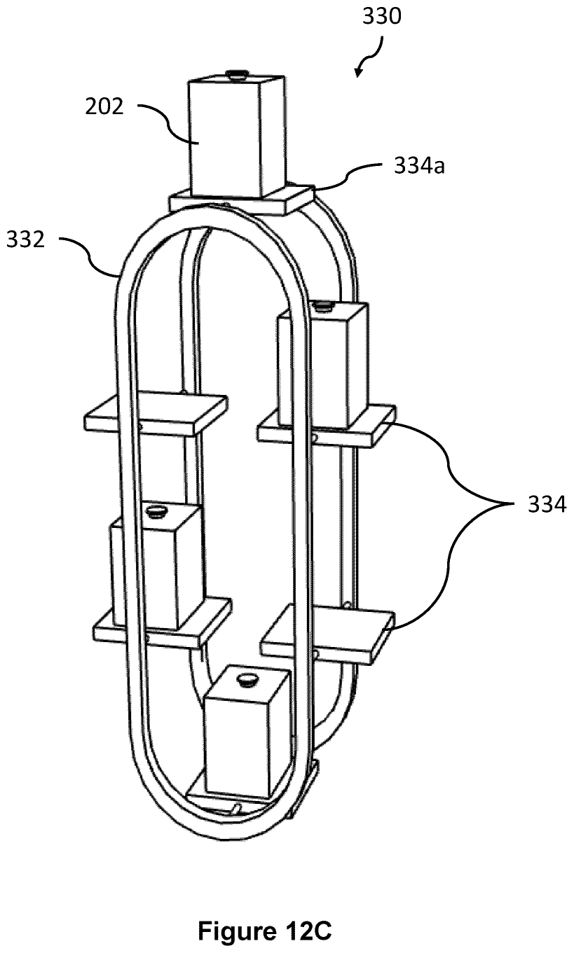

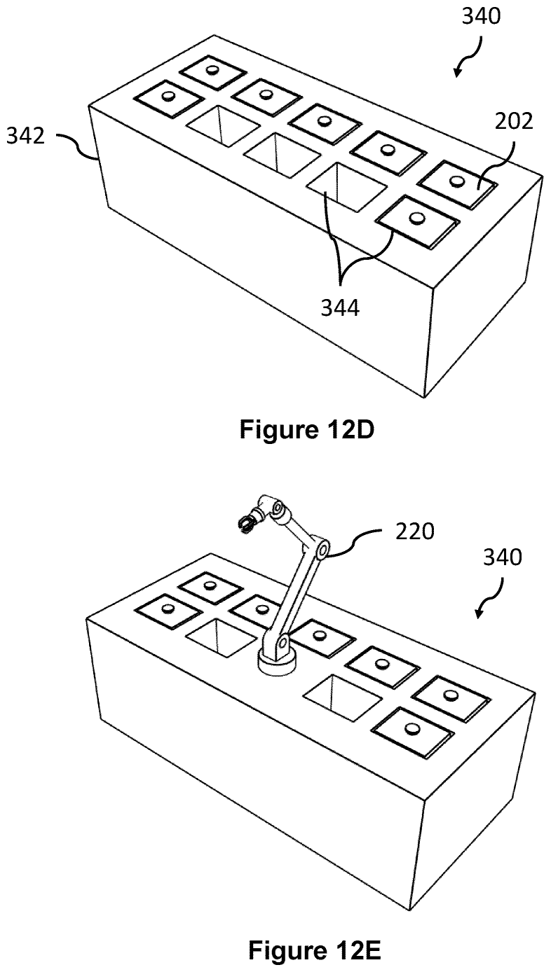

FIG. 12A shows a first example power source storage station 310 for storing power sources 202 in the above-described system. The storage station 310 comprises a plurality of power source holders 314, each configured to receive a power source 202. The power source holders 314 are shown as being vertically arranged in horizontally adjacent columns; however, the power source storage station 310 could be arranged in a single vertical column. In this illustrated example, the holders 314 are in the form of individual compartments within a storage structure 312, but the holders 314 can take any suitable form for receiving a power source 202, e.g. a shelf, a rack, a container etc.

The power source storage station 310 may be located on the platform 25 adjacent to the outer perimeter of the track structure 13, e.g. in the designated area 26, such that the power source holders 314 are accessible by the power source exchanging apparatus. The power source exchanging apparatus is configured to remove a depleted power source 202 from a bot 100 and place it into one of the vacant holders 314a. The power source exchanging apparatus is further configured to retrieve a replacement power source 202 from an occupied holder 314b and place it into the vacant power source compartment 150 of the bot 100.

The power source holders 314 of the storage station 310 are configured to receive the power sources 202 in a horizontal direction. This allows the power source holders 314 to be arranged in a space-efficient column arrangement and requires minimal horizontal footprint. The storage station 310 is suitable for use with robotic arms with enough degrees of freedom to orientate the power source 202 between a vertical orientation (for insertion or removal from the power source compartment 250) and a horizontal orientation (for insertion or removal from a power source holder 314). The storage station 310 may, for example, be used with a 6-axis robotic arm, such as the robotic arm 220 illustrated in FIG. 9.

FIG. 12B shows a second example power source storage station 320 with power source holders 324 vertically arranged in horizontally adjacent columns similar to the power source storage station 310 of FIG. 12A. However, in this example, the holders 324 are configured to vertically receive power sources 202 from above. To allow each individual holder 324 to be accessed from above, each holder 324 is configured to move or extend horizontally from a storage position in which the holder 324 is located within the structure 322, to a presentation position in which the holder 324 protrudes out of the structure 312 so that the top of a holder 324 is accessible to the end effector of a robotic arm from above. In this illustrated example, each holder 324 is in the form of a retractable shelf. When the power source exchanging apparatus is ready to place a power source 202 into the storage station 320, a vacant holder 324 moves from the storage position to the presentation position (represented by holder 324a) to receive the power source 202, and can then move back to the storage position. Similarly, when the power source exchanging apparatus is ready to retrieve a power source 202 from the storage station 320, a holder 324 occupied by a replacement power source 202 moves from the storage position to the presentation position (represented by holder 324b) so that the end effector can pick up the replacement power source 202. The holder 324 can then move back to the storage position.

By providing a power source storage station 320 with holders 324 configured to vertically receive a power source 202 and move between the storage and presentation positions described above, the storage station 320 can be used with a robotic arm that cannot re-orientate the power source about a horizontal axis (e.g. the robotic arm illustrated in FIG. 10), while still allowing the holders 324 to be arranged in a space-efficient column arrangement that has a minimal horizontal footprint.

FIG. 12C shows a third example power source storage station 330 in which the holders 334 are configured to vertically move between the storage position and the presentation position. In particular, the storage station 330 comprises a vertical carousel 332 on which the holders 334 are supported. The vertical carousel 332 is configured to selectively rotate about a horizontal axis so that each holder 334 can be selectively moved to a presentation position corresponding to the top of the carousel 332 (represented by holder 334a). The top of the carousel 332 is accessible from above such that the power source exchange apparatus can vertically insert or remove a power source 202 from a holder 334 in the presentation position.

In alternative examples, the vertical carousel 332 may support power source holders that are configured to receive power sources 202 in a horizontal direction. In this case, the presentation position does not necessarily have to correspond to the top of the carousel 332. Instead, one side of the vertical carousel 332 facing the power source exchanging apparatus may correspond to the presentation position and an opposing side of the vertical carousel 332 facing away from the power source exchanging apparatus may correspond to the storage position.

FIG. 12D shows a fourth example power source storage station 340 with power source holders 344 arranged in a horizontal plane within a storage structure 342. Each power source holder 344 comprises a top-facing opening in a top surface of the storage structure 342 to allow each power source holder 344 to removably receive a power source 202 in a downwards direction. The region in the storage structure 342 below the power source holders 344 may be used to house power source charging equipment for charging the power sources 202 when they are received in the power source holders 344. The fourth power source storage station 340 provides a similar advantage to the second and third example storage stations 320, 330 in that the power source 202 does not need to be re-orientated (e.g. about a horizontal axis) when transferring the power source 202 between a power source compartment and a power source holder, but is simpler than the second and third example power source storage stations 320, 330 in that it does not require the power source holders 344 to move between a storage position and a presentation position to receive a power source 202.

The power source holders of the above-described power source storage stations are optionally accessible from a rear side of the storage station to allow a power source 202 to be inserted into or removed from the power source holders from the rear side of the power source station. The rear side is defined as a side of the storage station facing away from the track structure 13. The rear side of the storage station may face a maintenance area accessible by human workers. This arrangement allows a power source 202 to be removed from the power source storage station by a human worker (e.g. for maintenance) without the worker having to be located in an area with potentially dangerous equipment (e.g. the track structure 13, the bot 100, the power source exchanging apparatus, etc.), or without having to shut down the potentially dangerous equipment.

The location of the power source storage stations described above are not limited to being adjacent to the outer perimeter of the track structure 13. The power source storage stations may be located at any other suitable location accessible by the end effector of a robotic arm, e.g. on the track structure 13 itself.

In some examples, a power source exchanging apparatus 220, 230 may be mounted on the power source storage station 310, 320, 330, 340 itself. For example, FIG. 12E shows an articulated robotic arm 220 mounted on the top surface of the storage structure 342 of the fourth example storage station 340. This power source storage station 340 may be located adjacent to the outer perimeter of the track structure 13 such that the end effector of the robotic arm 220 can transfer a power source 202 between a power source holder 344 and a bot 100 located on a designated grid cell 14a adjacent to the power source storage station 340. Instead of an articulated robotic arm 220, a robotic arm 230 in the form of a gantry or Cartesian robot may be mounted on the power source storage station 340 instead.

In some examples, each power source storage station 310, 320, 330, 340 may be associated with a plurality of power source exchanging apparatuses 220, 230. In other words, a plurality of power source exchanging apparatuses may be configured to transfer power sources 202 to and from the same power source storage station. For example, a plurality of robotic arms 220, 230 may be mounted on, or in the vicinity of, a single power source storage station to allow the power sources 202 of multiple bots 100 to be exchanged during the same time period or during overlapping time periods at a single power source storage station.

In the case where the power source 202 is a rechargeable power source, the power source holders of the power source storage stations described above preferably comprise power source charging means for charging the power sources 202 when received in the holders. For example, the power source holders 314, 324, 334, 344 may comprise electrical connectors (not shown) configured to couple to the electrical connectors of the power source 202, together with an external power supply (e.g. a mains power supply) and other electrical equipment (e.g. transformer, convertor etc.) to allow the external power supply to charge the power sources 202 when they are received in the power source holders. For the third example storage station 330, the vertical carousel 332 may comprise brush contacts or other known means for electrically coupling stationary and moving parts.

The power source holders of the power source storage stations may optionally comprise a locking mechanism for releasably locking a power source in a holder, similar to the locking mechanisms described above for releasably locking the power source 202 in the power source compartment 150.

The storage and retrieval system may comprise one or more control systems configured to control one or more of the movement of the bots 100 on the track structure 13, the locking mechanism for releasably locking the power source in the power source 202 compartment 150, the power source exchanging apparatus 220, 230 and the power source holders 314, 324, 334, 344 of the power source storage station 310, 320, 330, 340. The bot 100 and/or the power source 202 may comprise a battery monitoring system for monitoring the charge state of the power source 202 within the power source compartment 150. The power source storage station 310, 320, 330, 340 may also comprise a battery monitoring system to monitor the charge state of the power sources 202 within the power source holders 314, 324, 334, 344. The control system may use this information to determine: when a bot 100 should move to a designated grid cell 14a to have its power source 202 exchanged; the vacant power source holder 314, 324, 334, 344 into which the power source exchanging apparatus should place the depleted power source 202; and the occupied power source holder 314, 324, 334, 344 from which the power source exchanging apparatus should retrieve a replacement power source. For example, the storage and retrieval system may comprise a central control system for controlling the movement and functions of the bots 100 on the track structure 13 and for controlling the activation the power source exchanging apparatuses 220, 230 for performing power source exchanges. When the battery monitoring system of a power source in a bot 100 indicates that the charge state of the power source is low, a controller in the bot may send a signal to the central control system, which commands the bot to travel along a calculated route to a designated grid cell 14 so that its power source can be exchanged. Once the bot 100 has arrived at the designated grid cell 14, the bot can confirm its location to the central control system, which can then command a power source exchanging apparatus 220, 230 to perform a power source exchange. The bots 100 and the central control system may comprise a wireless transmitter and receiver so that they can wirelessly communicate with each other using known wireless communication technologies such as 4G, 5G, Wi-Fi, etc.

In addition to the power source 202, the bot 100 may optionally comprise a secondary power source configured to continue providing power to a controller in the bot when the primary power source 202 is removed from the power source compartment 150. The controller in the bot 100 may be configured to activate various mechanisms in the bot 100 (e.g. the driving assembly, the lifting mechanism, the container-holding device, etc.) and may comprise a communications module for transmitting and receiving signals to and from a central control system, as described above. The secondary power source may have a lower charge capacity than the primary power source 202 and may be a supercapacitor or a battery. The secondary power source may be charged by the primary power source 202 when the primary power source 202 is in the power source compartment 150. This use of a secondary power source allows the controller in the bot 100 to remain active during a power source exchange, so that the bot 100 does not need to spend time rebooting itself while occupying a designated grid cell 14a, and allows the bot 100 to stay in communication with the central control system during the power source exchange.

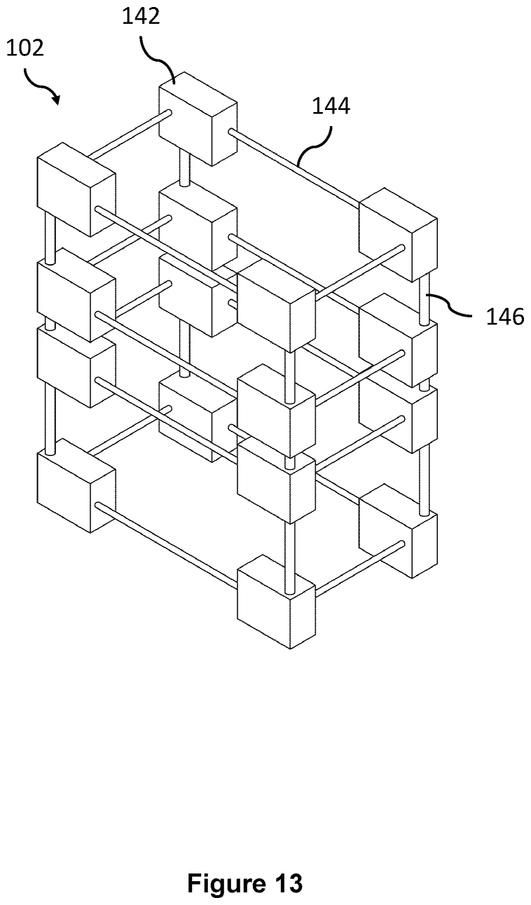

In the above-described examples, the external body 102 of the bot 100 is illustrated as having an external casing 130 comprising panels. However, the external casing 130 of the bot 100 may also have an open frame structure. In other words, of the external body 102 of the bot 100 may be defined by an open frame structure. FIG. 13 schematically shows an example of a body 102 having an open frame structure. In this example, the body 102 of the bot 100 comprises corner blocks 142 connected to each other by horizontal connecting elements 144 (e.g. rods) to form frames. In particular, four corner blocks 142 are connected by four horizontal connecting elements 144 to form rectangular frames. The external body of the bot 100 is formed as a vertical stack of rectangular frames, with vertically adjacent corner blocks 142 being connecting using vertical connecting elements 146. In the case of a bot 100 having an open frame structure, the top-facing opening 132 of the power source compartment 150 may be part of, or may be accessed via, a top-facing opening defined by the open frame structure (e.g. the opening through the top-most rectangular frame shown in FIG. 13). The power source compartment 150 may also be defined by a similar open frame structure, e.g. corner blocks connected by horizontal and vertical connecting elements.

The above description of embodiments of the invention has been presented for the purpose of illustration and description. It is not intended to be exhaustive or to limit the invention to the precise forms disclosed. Modifications and variations can be made without departing from the scope of the invention as defined in the claims.

1. A load handling device configured for lifting and moving containers arranged in stacks in a storage structure including a track structure with a first set of tracks and a second set of tracks, the first set of tracks extending in a first direction and the second set of tracks extending in a second direction, the second direction being substantially perpendicular to the first direction to form a grid pattern defining a plurality of grid cells above the stacks of containers, the load handling device comprising:
a driving assembly configured to horizontally move the load handling device on the track structure;
a lifting mechanism configured to lift a container from a stack;
a power source; and
an externally accessible power source compartment configured to electrically couple to the power source, wherein the power source compartment is configured to removably receive the power source in a vertical direction.

2. The load handling device of claim 1, wherein the power source compartment comprises:
a top-facing opening, and the power source compartment is configured to removably receive the power source in a downwards direction via the top-facing opening.

3. The load handling device of claim 2, wherein the top-facing opening is defined by an external body of the load handling device.

4. The load handling device of claim 2, wherein the top-facing opening is at least partially defined by one or more locating surfaces that taper downwards towards the power source compartment.

5. The load handling device of claim 1, wherein the power source compartment is configured to electrically couple to the power source when the power source is vertically received into the power source compartment and electrically uncouple from the power source when the power source is vertically removed from the power source compartment.

6. The load handling device of claim 5, wherein the power source compartment comprises:
an electrical connector configured to electrically couple to a corresponding electrical connector of the power source when the power source is vertically received into the power source compartment and the electrical connectors of the power source compartment and the power source face in opposing vertical directions.

7. The load handling device of claim 1, further comprising:
a locking mechanism configured to releasably lock the power source in the power source compartment.

8. The load handling device of claim 7, wherein the locking mechanism comprises:
a first locking member located in the power source compartment or on the power source, and a second locking member located on the power source or in the power source compartment respectively, wherein the first locking member is configured to move between a locking position in which the first locking member blocks the second locking member in a vertical direction to prevent the power source from moving vertically out of the power source compartment, and a release position in which the power source is free to move vertically out of the power source compartment.

9. The load handling device of claim 7, wherein the locking mechanism is configured such that vertical insertion of the power source into the power source compartment will automatically lock the power source in the power source compartment.

10. The load handling device of claim 8, wherein the first locking member is biased towards the locking position.

11. The load handling device of claim 10, wherein the locking mechanism comprises:
a release mechanism configured to move the first locking member against the biasing force to the release position when activated.

12. The load handling device of claim 8, wherein the locking mechanism comprises:
an actuator configured to selectively move the first locking member between the locking position and the release position.

13. The load handling device of claim 7, wherein the locking mechanism is configured to lock the power source in the power source compartment when the power source is rotated about a vertical axis in a first direction relative to the power source compartment and release the power source from the power source compartment when the power source is rotated about the vertical axis in a second direction opposite to the first direction relative to the power source compartment.

14. The load handling device of claim 1, wherein the power source comprises:
a cylindrical external casing having a longitudinal axis, and the power source compartment is configured to receive the power source such that the longitudinal axis is vertically orientated.

15. The load handling device of claim 1, wherein the load handling device comprises:
a container-receiving space for receiving a container lifted by the lifting mechanism, and the power source compartment is located above the container-receiving space.

16. The load handling device of claim 1, wherein the power source is a rechargeable power source.

17. A load handling device according to claim 1, in combination with a storage and retrieval system, the system comprising:
a storage structure including a track structure with a first set of tracks and a second set of tracks, the first set of tracks extending in a first direction and the second set of tracks extending in a second direction, the second direction being substantially perpendicular to the first direction to form a grid pattern defining a plurality of grid cells;
a plurality of stacks of containers arranged within the storage structure, each stack being arranged below a grid cell;
the load handling device configured to move horizontally on the track structure; and
a power source exchanging apparatus including an end effector configured to releasably hold the power source and move vertically relative to the load handling device to vertically remove the power source from and/or vertically insert the power source into the power source compartment.

18. The storage and retrieval system of claim 17, wherein the end effector is configured to move horizontally relative to the load handling device.

19. The storage and retrieval system of claim 17, wherein the power source exchanging apparatus comprises:
a base located on or adjacent to the track structure and the end effector is moveable relative to the base.

20. The storage and retrieval system of claim 19, wherein the base is horizontally moveable relative to the track structure.

21. The storage and retrieval system of claim 17, wherein the power source exchanging apparatus comprises:
a frame mounted directly above at least a portion of the track structure, and the end effector is supported above the track structure by the frame.

22. The storage and retrieval system of claim 21, wherein the frame comprises:
a horizontal beam mounted above a row of grid cells, and the end effector is configured to move horizontally along the horizontal beam.

23. The storage and retrieval system of claim 22, wherein the horizontal beam is configured and arranged to be horizontally moveable in a direction perpendicular to the longitudinal axis of the horizontal beam.

24. The storage and retrieval system of claim 17, wherein the power source exchanging apparatus is configured to move the end effector to any one of a plurality of designated grid cells to allow the end effector to remove the power source from and/or insert the power source into the power source compartment when the load handling device is at any one of the plurality of designated grid cells.

25. The storage and retrieval system of claim 17, wherein the power source exchanging apparatus is a robotic arm.

26. The storage and retrieval system of claim 17, wherein the power source exchanging apparatus comprises:
a first end effector configured, in use, to vertically remove a power source from the power source compartment of the load handling device and a second end effector configured, in use, to vertically insert a power source into the power source compartment of said load handling device.

27. The storage and retrieval system of claim 17, comprising:
a power source storage station including at least one power source holder configured to receive the power source; and
wherein the power source exchanging apparatus is configured, in use, to move the power source between the load handling device and the power source storage station.

28. The storage and retrieval system of claim 27, wherein the power source is a rechargeable power source and the power source holder is configured to charge the rechargeable power source when received in the power source holder.

29. The storage and retrieval system of claim 27, wherein the power source holder is configured to removably receive the power source from a horizontal direction.

30. The storage and retrieval system of claim 29, wherein the power source exchanging apparatus is configured to orientate the power source about a horizontal axis between a vertical orientation for inserting or removing the power source from the power source compartment and a horizontal orientation for inserting or removing the power source from the power source holder.

31. The storage and retrieval system of claim 27, wherein the power source holder is configured to removably receive the power source in a vertical direction from above.

32. The storage and retrieval system of claim 31, wherein the power source storage station is configured to move the power source holder between a presentation position in which the power source holder is accessible to the end effector from above and a storage position in which the power source holder is not accessible to the end effector from above.

33. The storage and retrieval system of claim 32, wherein the power source holder is configured and arranged to be horizontally movable between the storage position and the horizontal position.

34. The storage and retrieval system of claim 32, wherein the power source holder is configured and arranged to be vertically movable between the storage position and the horizontal position.

35. The storage and retrieval system of claim 34, wherein the power source storage station comprises:
a vertical carousel on which the power source holder is arranged, and the vertical carousel is configured to rotate about a horizontal axis to selectively move the power source between the presentation position and the storage position.

36. The storage and retrieval system of claim 27, wherein the power source storage station is located on or adjacent to the track structure.

37. The storage and retrieval system of claim 36, wherein the power source storage station has a rear side facing away from the track structure, and wherein the power source holder is accessible from the rear side to allow a power source to be inserted into or removed from the power source holder from the rear side of the power source storage station.

38. The storage and retrieval system of claim 27, wherein the power source storage station comprises:
a plurality of power source holders, each configured to receive a power source.

39. A method of exchanging a power source in a power source compartment of a load handling device which includes:
a driving assembly configured to horizontally move the load handling device on the track structure;
a lifting mechanism configured to lift a container from a stack;
a power source;
an externally accessible power source compartment configured to electrically couple to the power source, wherein the power source compartment is configured to removably receive the power source in a vertical direction the method comprising:
(i) vertically removing a first power source from the power source compartment; and
(ii) vertically inserting a second power source into the power source compartment.

40. The method of claim 39, wherein the load handling device remains stationary in at least a horizontal direction from when the first power source is removed to when the second power source is inserted.
